(19) United States
(12) Patent Application Publication
(10) Pub. No.: US 2006/0019058 A1
(43) Pub. Date: Jan. 26, 2006

(54) Reinforced means

(76) Inventor: Stephen Arthur Dickins, Whangaparaoa (NZ)

Correspondence Address: YOUNG & THOMPSON, 745 SOUTH 23RD STREET, 2ND FLOOR, ARLINGTON, VA, 22202, US

(21) Appl. No.: 11/172,879

(22) Filed: Jul. 5, 2005

(30) Foreign Application Priority Data
Jul. 6, 2004 (NZ) 533929

(51) Int. Cl. B32B 33/00

(52) U.S. Cl. 428/95; 428/40.1; 428/97

(57) ABSTRACT

This invention relates to reinforcement of various items by the use of a fibre substrate such as filament tape. The reinforced items may be used for strengthening abrasive paper, packaging and cabling.

### FIELD OF THE INVENTION

This invention relates to improvements in or relating to a reinforced means.

### BACKGROUND OF THE INVENTION

There are many types of abrasive products currently available for use in jewellery manufacture and finishing. Typically, these abrasive products consist of a form of abrasive substrate (such as emery, silicon carbide, or aluminum oxide crystals) bonded (usually by glue or some form of synthetic resin) to a form of backing substrate. Three main types of backing substrate arc commonly used: cloth backing (e.g. emery cloth), paper backing (e.g. sandpaper) or flat wooden sticks or handles (e.g. emery sticks).

All these types of abrasive products can be difficult to use and there are some common problems inherent in their use. In particular, most cloth-backed abrasive products are too thick and are therefore unable to be used in very small spaces such as are common in jewellery manufacture. Furthermore, the cloth used is generally comprised of fibres which are interwoven across each other, and therefore they have limited tension, and tend to pull apart easily, especially when provided as, or formed into, narrow strips. This type of interwoven construction can also result in ‘bunching’ during use. Also, cloth-backed abrasive products tend to use “pointed” grit which may result in undesirable scratch patterns when used.

However the principal problem with paper-backed abrasive products is that they lack durability. The paper backing quickly wears and tears, usually before the abrasive substrate reaches its optimum use. Therefore paper-backed products can be expensive, as they frequently need to be replaced. For example, in a typical manufacturing jewellers over a six month period with two users, it would be common to use about 21 sheets of emery paper.

Furthermore if the paper gets wet, for example when polishing, the paper can readily tear or disintegrate.

Emery sticks have obvious disadvantages in that they can be too thick and inflexible due to the heavier paper or wood backing substrate, and therefore cannot be used in small spaces or to finish corners.

Abrasive papers when used with a disc sander also have disadvantages, for example, when used by boat builders the paper easily tears and reduces in size leading to damage to the backing pad which is usually made of a foam material. When sanding or polishing boat builders will usually not sand or polish into joining points such as corners because the paper disc will frequently cut into the curved corners which corners are usually made by the use of settable resins. The sanding discs may also be difficult to remove from the foam pad.

Various packaging materials are also disadvantageous, for example, the material having bubbles of air trapped between two plastics layers, frequently called bubblewrap is difficult to tear in a selected direction as the tear line tends to wander. Polystyrene packaging however readily tears or punctures.

### OBJECT

It is therefore an object of the present invention to provide reinforced means which will go at least some way towards overcoming at least some of the foregoing disadvantages in a simple yet effective manner or which will at least provide the public with a useful choice.

### STATEMENT OF INVENTION

Accordingly, in one aspect, the invention consists in a reinforced means comprising a fibre substrate containing at least one self-adhesive surface to which a further layer is adhered.

Preferably, said fibre substrate is formed of a type of material wherein the fibres in the material are aligned in substantially the same direction and are not interwoven.

Preferably, the fibres within said fibre substrate are formed of glass filaments or fibreglass or similar material.

Preferably, said fibre substrate is a strong self-adhesive packaging tape.

Preferably, said fibre substrate is substantially 0.1 mm in thickness.

Preferably, the fibre substrate according to any one of the preceding paragraphs carries double-sided adhesive surfaces to which two separate abrasive layers are affixed to form in use a saw blade.

Preferably, the further layer is an abrasive layer.

Preferably, said abrasive layer is any existing abrasive product comprising a paper backing.

Preferably, said abrasive layer comprises sandpaper or emery paper.

Preferably, said abrasive layer is substantially 0.2 mm in thickness.

Preferably, said fibre substrate and said abrasive layer are of an equal length and width such that when they are combined they form a single symmetrical sheet of abrasive means, such length and width being selected according to the desired use.

Preferably, the resulting abrasive means is substantially 0.3 mm in thickness.

Preferably, said sheets of abrasive means are scribed and folded around a thin elongated wooden stick such as a ruler such that a sharper edge is retained in use.

Preferably, said abrasive means is cut into strips of a selected length and width according to desired use.

Preferably, said abrasive means when cut into strips is cut along the length in the same direction as the substantially aligned fibres on the fibre substrate such that maximum strength is retained in use.

Preferably, said strips of abrasive means are supported in a saw frame such that maximum tension is retained in use.

Preferably, said strips of abrasive means are supported in a buffing wheel in use.

Preferably, said sheets of abrasive means are supported in rolls, discs, belts or any other devices which are designed to support abrasive products, in use.

Preferably, reinforced means when for use on a disc further includes a strip of adhesive.

Preferably, strip of adhesive is narrower than width of the reinforced means.

Preferably, a water resistant layer is provided between said substrate and said abrasive layer in use.

Preferably, said water resistant layer comprises an open web layer of plastics material.

Alternatively, said further layer comprises a layer of bubble wrap.

Preferably, said further layer comprises a layer of expanded closed cell plastics material.

Preferably, said expanded closed cell plastics material comprises expanded polystyrene.

Alternatively, said further layer comprises a further layer of said fibre substrate, one or more tendons being encapsulated between the two layers of fibre substrate.

Preferably, said tendons lie parallel to the direction of the fibres in the fibre substrate.

Preferably, the tendons comprise electrical conductors.

To those skilled in the art to which the invention relates many changes in construction and widely differing embodiments and applications of the invention will suggest themselves without departing from the scope of the invention as defined in the appended claims. The disclosures and the description herein are purely illustrative and are not intended to be in any sense limiting.

### DRAWINGS DESCRIPTION

One preferred form of the invention will now be described with reference to the accompanying drawings in which,

FIG. 1 is a diagrammatic element showing an abrasive means according to one preferred form of the invention,

FIG. 2 is cross-sectional end view showing an abrasive means according to one preferred form of the invention,

FIGS. 3a, 3b and 3c are diagrammatic elements showing typical uses of an abrasive means according to one preferred form of the invention.

FIG. 4 is a diagrammatic side elevation of a further embodiment of the invention in the form of a disc sanding sheet,

FIG. 5 is a diagrammatic plan view of the embodiment of FIG. 4,

FIG. 6 is a view as in FIG. 1 of a further alternative reinforced means,

FIG. 7 is a diagrammatic cut away view of the embodiment of FIG. 6,

FIG. 8 is a diagrammatic side elevation of a packaging clement according to a further embodiment of the invention,

FIGS. 9 and 10 are diagrammatic side elevations of further embodiments of the invention usable as packaging elements, and

FIG. 11 is a diagrammatic side elevation of a still further embodiment of the invention

### DETAILED DESCRIPTION

Referring to the drawings, an improved reinforced means is provided which essentially includes a fibre substrate 1. The fibre substrate 1 is combined with one or more other layers to construct the reinforced means.

In first embodiments the fibre substrate is adhered to an abrasive layer or layers 2.

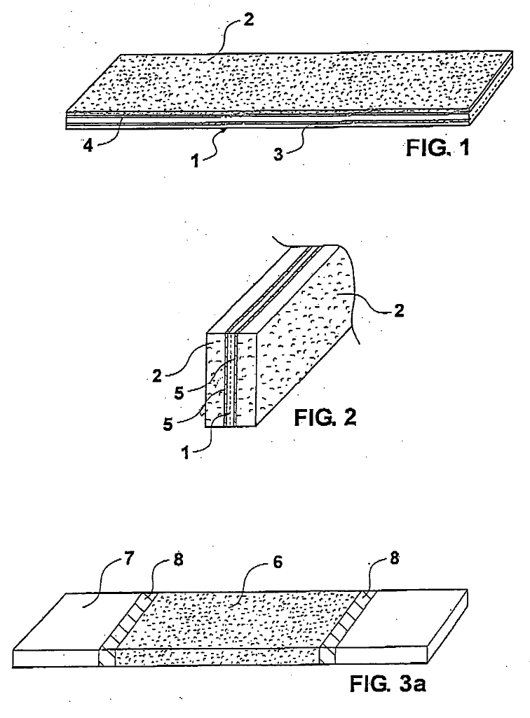

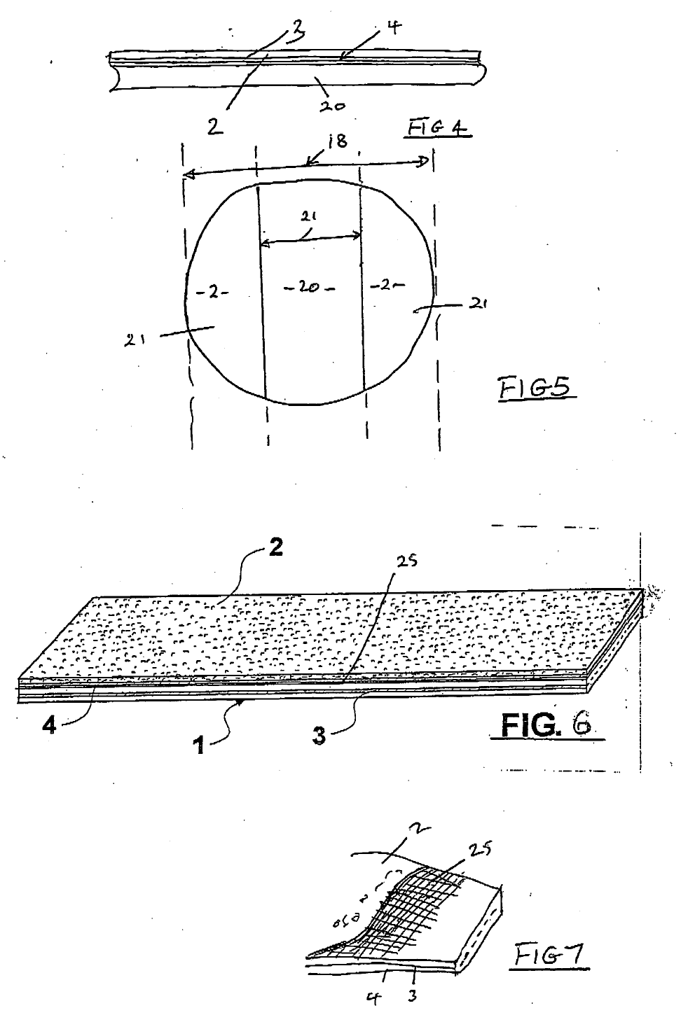

Referring to FIGS. 1 to 7 a fibre substrate 1 is formed preferably from some type of strong self-adhesive packaging tape, such as filament tape, the material of said tape comprising thin fibres or filaments 3 made of glass or fibreglass or a similar type of material, which are aligned substantially in the same direction along the length of the tape such that the tape has a high degree of strength. The fibre substrate 1 has a single adhesive surface 4 (FIG. 1) or has double-sided adhesive surfaces 5 (FIG. 2). The fibre substrate 1 is substantially thin. Preferably, comprising a thickness of no more than 0.1 mm. However, the fibre substrate 1 may be of any selected thickness, as may be selected for a particular use. The fibre substrate 1 is preferably in the form of an elongated strip but may consist of or be cut to any selected length, width or shape, as may be desired in use. The fibre substrate 1, if cut into strips is readily cut along its length in the same direction as the fibres or filaments 3. The fibres or filaments 3 on the fibre substrate 1 could be given a distinctive colour to identify the product if desired.

The abrasive layer 2 is formed preferably from an existing paper-backed abrasive product, such as emery paper or sandpaper. The abrasive layer 2 is substantially thin, comprising a thickness of preferably no more than 0.2 mm. However, the abrasive layer 2 may be of any selected thickness, as may be selected for a particular use. The abrasive layer 2 is preferably in the form of an elongated strip but may consist of or be cut to any selected length, width or shape, as may be selected for a particular use.

The fibre substrate 1 and the abrasive layer 2 are preferably of substantially the same length, width or shape or are cut to substantially the same length, width or shape.

The abrasive layer 2 is affixed to the fibre substrate 1 by means of the adhesive surface 4 or surfaces 5 of the fibre substrate 1, to form a sheet of the abrasive means of the invention. Preferably, once the fibre substrate 1 and abrasive layer 2 are combined, the abrasive means comprises a total thickness of no more than 0.3 mm. However, the abrasive means may be of any selected thickness (being the combined thickness of the fibre substrate 1 and the abrasive layer 2) as may be desired in use. The abrasive means may be cut into any desired size or shape, for example, into square sheets or strips or similar, as may be required in use. The abrasive means if cut into strips, is usually cut along its length in the same direction as the fibres or filaments 3 of the fibre substrate 1 to ensure the strips retain maximum strength in use.

In one preferred form of the invention as depicted in FIG. 2, two sheets of abrasive layer 2 are affixed to either side of the double-sided adhesive surfaces 5 of the fibre substrate 1 to form a type of saw blade in use.

In one preferred form of the invention, the abrasive means may be further affixed to a saw frame such that maximum tension is retained in use and maximum flexibility is retained to work in very small and normally inaccessible places.

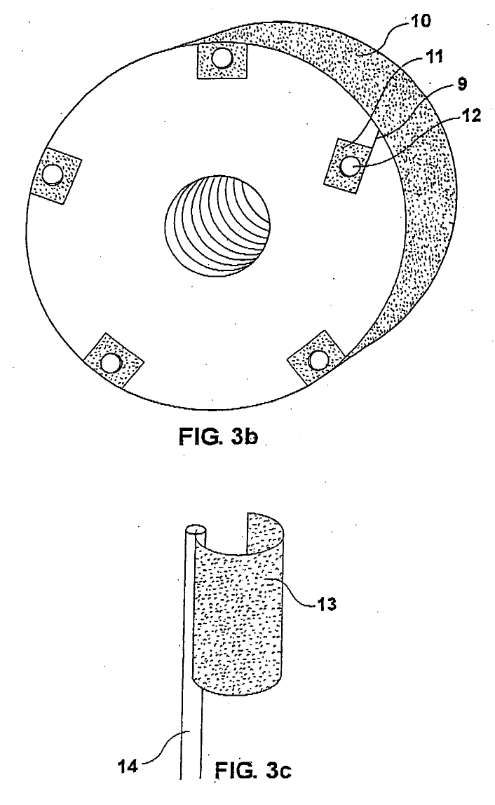

In a further preferred form of the invention, as depicted in FIG. 3a, a sheet of the abrasive means 6 may be scribed and folded tightly around a thin elongated shaft 7 made of a suitably rigid material, such that a sharper edge is retained in use. The abrasive means 6 is scribed and folded such that the fibres or filaments 3 on the fibre substrate 1 extend in a direction lengthwise of the elongated shaft 7. The abrasive means 6 is secured by some means such as adhesive tape 8 to each end of the elongated shaft 7. Thus in use, as the top surface of the abrasive means 6 wears down, it can be removed by firstly tearing the abrasive means 6 crosswise along either taped edge of the elongated shaft 7 and then tearing the abrasive means 6 lengthwise along any edge of the elongated shaft 7 (and thus along the length of the fibres or filaments 3 on the fibre substrate 1 which will tear true), such that a new surface is available for use.

In a further preferred form of the invention, as depicted in FIG. 3b, the abrasive means may be affixed to a supporting structure such as a buffing wheel. A small slot 9 is cut into the buffing wheel and the end of a strip of the abrasive means 10 is inserted into the slot 9 and wound around the wheel. The abrasive means 10 is secured in place by means of several tabs 11 which are cut out as the abrasive means 10 is cut into strips for use. These tabs 11 are then fastened with pins or some other fastening devices 12 into the buffing wheel. Thus in use, as any surface of the abrasive means 10 wears down, it can be repositioned around the wheel such that a new surface is available for use.

The abrasive means may be used in any other supporting devices which are designed to support abrasive products, such as depicted in FIG. 3c which shows a small piece of abrasive means 13 attached to a pin like structure 14, for use in very small spaces.

In the construction of the FIG. 4 an adhesive layer 4 adheres the abrasive or polishing layer 2 to the layer including filaments 3. The construction may be made in elongated strips having a selected width, for example, 115 mm or 150 mm or any other width as desired and as indicated by arrow 18.

To the strip 4 on the opposite face to the face carrying the abrasive layer 2 is provided an adhesive strip 20. This is desirably a double side adhesive strip and may be provided in a lesser width than the width of the substrate 4 and abrasive layer 2, for example, about 50 mm as indicated by arrow 21.

The construction may be made in elongated strips which are then cut to the desired length and may also be cut to a round or other selected shape if desired.

In use the available side of the double sided adhesive strip 20 is adhered to a sanding disc, for example, a foam disc by means of the strip 20. It will be apparent that the side parts 21 are two at least some extent free, that is to say not adhered to the foam disc. When the disc has been used the double sided adhesive can be readily removed from the foam layer by simply gripping one of the free-edged parts 21 and pulling the abrasive disc from the grinder pad.

In the embodiments of FIGS. 6 and 7 a further layer 25 is included, between the layers 2 and 4, this being formed of a waterproof material preferably an open waterproof plastics web, for example, of nylon. This material is waterproof and therefore in use of any of the embodiments herein before described in the event that the paper becomes wet there is little or no tendency for the layer 2 to separate from the layer 4. Such a construction is particularly useful for man of the polishing operations undertaken by jewellers where liquids are involved.

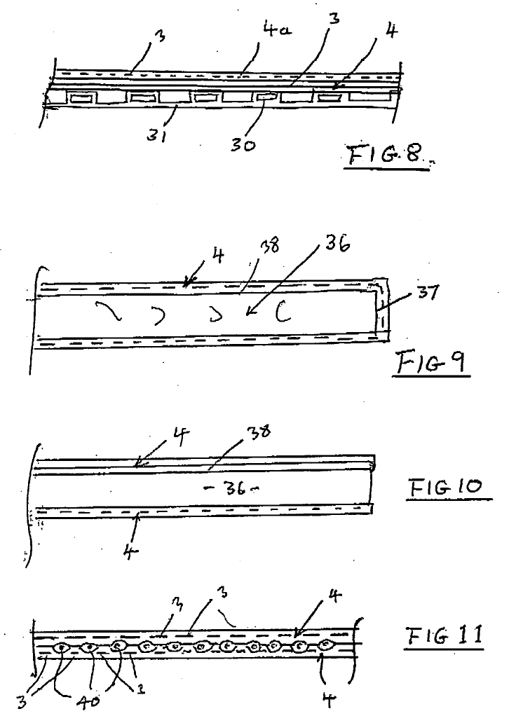

Turning now to the embodiment of FIG. 8 a construction is shown of the type where material have encapsulated air pockets 30 in a sheet material 31 is provided. This material is often known by the name of “bubblewrap”.

A layer 4 of the filament holding material is placed across the top of the bubbles so that the filaments run in a first selected direction.

This material is suitably adhered to the top of the bubbles and if desired a further layer 4a may be placed over the layer 4, for example, with the filaments 3 running in a different selected directions, for example, at right angles to the first direction.

With the embodiment having only layer 4 the bubblewrap material can be readily torn along the line parallel to the filaments 3. The reinforcing caused by the filaments of the bubblewrap material 31 in essence forces tearing to occur along that line.

If the second layer 4a is added the material becomes difficult to tear becoming resistant to tearing because of the cross nature of the filaments 3 in the layers 4 and 4a. The material is also substantially resistant to piercing and puncturing.

In an alternative embodiment of the invention the bubblewrap layer 31 may be replaced by other material such as corrugated cardboard in which case the provision of the substrate layer 4 or the two substrate layers 4 and 4a makes the material resistant to piercing and puncturing.

As the layer 4 is substantially transparent the construction enables labels, for example, to be placed under the packaging where such labels will still be largely visible.

The filament tape can be used to back many different materials to impact strength. For example the filament tape could be applied to layers of wool, or cotton such as denim material. Such materials have several uses such as polishing pads.

Turning now to the embodiments of FIGS. 9 and 10 the substrate layers 4 are adhered to a layer of somewhat brittle material such as a layer 36 of an expanded closed cell foam material such as, for example, expanded polystyrene although the invention can be used with other materials. It is found that adhering the substrate material 4 over at least one but preferably at least both major surfaces and also if desired over the side surfaces 37 that the polystyrene or other somewhat brittle material becomes substantially resistant to cracking and scuffing.

It is found that the material can be “scrunched up” and still return substantially to its original shape. The material also resists substantial abuse in the form of hammering or the like. The strength can be further enhanced by providing a further layer in the nature of layer 4a shown in FIG. 8. Also if desired as shown in FIG. 10 layers could run in opposite directions on opposite sides of the layer 36.

The material has substantial use as a packaging material and also could be used in other application such as a manufacture of furniture. It is also envisaged that the material could have substantial use if the substrate layer 4 was provided all only on one major surface, for example, surface 38 of the layer 36. The layer 36 can be relatively thin, for example, about 5 mm to 10 mm thick. With a thickness of 10 mm the material is to have good resistance to tearing, scrunching, wrapping and hammering. The thinner 5 mm layer is found to have good resistance at least to tearing, scrunching and wrapping although the resistance to hammering is somewhat less than the 10 mm thicknesses.

It is envisaged that the material could be supplied, for example, in 1 mm widths so that it can be torn or cut into the required widths. The material could also be used for insulation such as for coolers and chilly bins. This is also envisaged that the material could be used for soundproofing purposes.

Where the filaments run in single direction it will be found that polystyrene can be caused to tear in the direction of the filaments readily.

Turning now to the embodiment of the invention shown in FIG. 11 a pair of strips of material 4 are applied face to face, that is to say adhered one to the other. However, before two layers of material 4 are adhered together tendons, indicated at 44 for example, are placed on layer 4 so as to be positioned between filament strips 3. The second layer of material 4 is adhered so that the filaments or tendons 40 are positioned substantially between the filaments 3 in each layer 4. In a preferred embodiment of the invention the tendons 40 may be electrically conducting and can be used, for example, as power cables or telephone cables.

The construction allows cables to be laid with a minimum of need to drill holes in the wall, form cavities or to thread cables through holes in cavities. In order to cross a floor the material can simply be laid on the floor prior to carpeting. The tendons are therefore somewhat independent of the positioning of walls allowing connection boxes to be positioned in the most appropriate position for case of use.

The construction also allows “late minute” decisions to be made as to the positioning of connection boxes and also allows late minute changes to be made.

Also the appropriate number of tendons or wire can simply be split off from the reel or stock of material and also the tendons or wires can be coloured coded as the colour will simply show through the transparent or translucent layer 4. Suitable colouring also assists in indication of each end of the wires.

Thus it can be seen that an improved abrasive means is provided in which the fibre substrate 1, due to the way in which the fibres or filaments 3 therein are constructed and aligned, provides an extremely strong, highly flexible and durable backing for the abrasive layer 2 such that tearing is prevented and the flexible adhesive bond results in a longer lasting material, and thus a more cost-effective abrasive product. For example, in a typical manufacturing jewellers over a six month period, two users would typically use about 4.3 sheets of the improved abrasive means as described herein, compared to 21 sheets of regular abrasive paper. Furthermore, in use, an abrasive means is provided which is thin enough to be used in very small spaces. Due to the construction of the fibre substrate 1, bunching is prevented during use and durability is retained (there is no build up of resin deposits as excess resin can be brushed off). Also, the adhesiveness of the fibre substrate 1 helps to resist loading and heat build up during use.

Furthermore the product does not fray or tend to disintegrate at overlapped ends when wrapped around a supporting structure such as a buffing wheel. The abrasive means of the invention is also effective in wet or dry situations, and it is also easy to handle. The construction of the abrasive means reduces lost time caused by paper changeover as the improved abrasive product as described does not need to be changed so frequently.

The abrasive means as described may come in a wide range of formats, including but not limited to sheets, strips, rolls, discs, and belts. I believe that the abrasive means according to the invention has many applications other than in the field of manufacturing jewellery, and can be used in any industry which requires the use of a stronger, longer lasting and more cost effective abrasive product or finishing medium.

Referring now to the embodiment of the invention in FIG. 4 the disc has the advantage of flexibility so that the sanding operation or polishing operation can follow natural curves of the surface to be sanded or polished. Thus, machine sanding or polishing can be used even in curves made by settable resin materials. It is found that the paper will outlast standard known sanding papers and it is a particular advantage of the construction that the discs may be easily removed from the grinder pad by simply grasping one of the free edges 21 and pulling the disc from the grinder. It is also an advantage of this construction that a wide range of quick finishes are able to be provided.

The construction of FIGS. 6 and 7 has the advantage that the construction is provided with enhanced strength in wet conditions.

The material of FIG. 8 enables the material of the type known as bubblewrap to be readily torn along predetermined lines or in the alternative construction to have substantial resistant to tearing.

In the construction of FIGS. 9 and 10 there is an advantage that a somewhat brittle material such as expanded polystyrene sheeting retains its integrity even when subject to substantial abuse such as scrunching up and hammering. Thus, the polystyrene or other similar material is able to be used in situations where its insulation properties and for example its properties of softening some blows are of value but in circumstances where the polystyrene foam is able to be shaped and twisted to shape and also to have blow softening properties enlarged in that a substantially greater amount a number of blows are required to damage the material.

Within the construction of FIG. 11 there is the advantage that in particular wires, for example, for telephones or power are able to be laid, for example, for directly onto to a floor such as concrete floor foundation. The need to drill holes in the wall or to provide cavities and to thread cables is substantially reduced. For example, telephone cables can be laid immediately prior to the laying of carpets over the floor. This enhances the period of time that a house owner has before finally deciding on the position of connection boxes. The arrangement also allows last minute decisions to be made to reposition connection boxes or indeed to add further boxes. The number of cables, strands or tendons needed can be simply stripped from the bulk roll as desired. Cable colour is readily visible through the coating materials.

Throughout the description and claims of this specification the word “comprise” and variations of that word, such as “comprises” and “comprising”, are not intended to exclude other additives, components, integers or steps.

1. A reinforced means comprising a fibre substrate containing at least one self-adhesive surface to which a further layer is adhered.

2. A reinforced means as claimed in claim 1 wherein said fibre substrate is formed of a type of material wherein the fibres in the material are aligned in substantially the same direction and are not interwoven.

3. A reinforced means as claimed in claim 2 wherein the fibres within said fibre substrate are formed of glass filaments or fibreglass or similar material.

4. A reinforced means as claimed in any one of the preceding claims wherein said fibre substrate is a strong self-adhesive packaging tape.

5. A reinforced means as claimed in any one of the preceding claims wherein said fibre substrate is substantially 0.1 mm in thickness.

6. A reinforced means as claimed in any one of the preceding claims wherein the fibre substrate carries double-sided adhesive surfaces to which two separate abrasive layers are affixed to form in use a saw blade.

7. A reinforced means as claimed in claim 6 wherein the further layer is an abrasive layer.

8. A reinforced means as claimed in claim 7 wherein said abrasive layer is any existing abrasive product comprising a paper backing.

9. A reinforced means as claimed in either one of claims 7 and 8 wherein said abrasive layer comprises sandpaper or emery paper.

10. A reinforced means as claimed in any one of claims 7 to 9 wherein said abrasive layer is substantially 0.2 mm in thickness.

11. A reinforced means as claimed in any one of claims 7 to 11 wherein said fibre substrate and said abrasive layer are of an equal length and width such that when they are combined they form a single symmetrical sheet of abrasive means, such length and width being selected according to the desired use.

12. A reinforced means as claimed in any one of claims 7 to 11 wherein the resulting abrasive means is substantially 0.3 mm in thickness.

13. A reinforced means as claimed in any one of claims 7 to 12 wherein said sheets of abrasive means are scribed and folded around a thin elongated wooden stick such as a ruler such that a sharper edge is retained in use.

14. A reinforced means as claimed in any one of claims 7 to 13 wherein said abrasive means is cut into strips of a selected length and width according to desired use.

15. A reinforced means as claimed in claim 14 wherein said abrasive means when cut into strips is cut along the length in the same direction as the substantially aligned fibres on the fibre substrate such that maximum strength is retained in use.

16. A reinforced means as claimed in claim 15 wherein said strips of abrasive means are supported in a saw frame such that maximum tension is retained in use.

17. A reinforced means as claimed in claim 15 wherein said strips of abrasive means are supported in a buffing wheel in use.

18. A reinforced means as claimed in claim 14 wherein said sheets of abrasive means are supported in rolls, discs, belts or any other devices which are designed to support abrasive products, in use.

19. A reinforced means as claimed in claim 18 wherein the reinforced means when for use on a disc further includes a strip of adhesive.

20. A reinforced means as claimed in claim 19 wherein said strip of adhesive is narrower than width of the reinforced means.

21. A reinforced means as claimed in any one of claims 7 to 19 wherein a water resistant layer is provided between said substrate and said abrasive layer in use.

22. A reinforced means as claimed in claim 21 wherein said water resistant layer comprises all open web layer of plastics material.

23. A reinforced means as claimed in any one of claims 1 to 6 wherein said further layer comprises a layer of bubble wrap.

24. A reinforced means as claimed in any one of claims 1 to 6 wherein said further layer comprises a layer of expanded closed cell plastics material.

25. A reinforced means as claimed in claim 24 wherein said expanded closed cell plastics material comprises expanded polystyrene.

26. A reinforced means as claimed in any one of claims 1 to 6 wherein said further layer comprises a further layer of said fibre substrate, one or more tendons being encapsulated between the two layers of fibre substrate.

27. A reinforced means as claimed in claim 26 wherein said tendons lie parallel to the direction of the fibres in the fibre substrate.

28. A reinforced means as claimed in either one of claims 26 and 27 wherein the tendons comprise electrical conductors.

29. A reinforced means substantially as herein described in any one of the embodiments herein with reference to the accompanying drawings.
